(19) United States
(12) Patent Application Publication
(10) Pub. No.: US 2010/0289867 A1
(43) Pub. Date: Nov. 18, 2010

(54) Method and System for Launching a Scheduled Conference Based on the Presence of a Scheduled Participant

(75) Inventor: Alain Nimri, Austin, TX (US)

Correspondence Address: WONG, CABELLO, LUTSCH, RUTHERFORD & BRUCCULERI,;L.L.P., 20333 SH 249 6th Floor, HOUSTON, TX, 77070, US

(73) Assignee: Polycom, Inc., Pleasanton, CA (US)

(21) Appl. No.: 12/779,382

(22) Filed: May 13, 2010

Related U.S. Application Data
(60) Provisional application No. 61/177,942, filed on May 13, 2009.

(51) Int. Cl. H04N 7/14; H04M 3/42

(52) U.S. Cl. 348/14.08; 379/202.01; 348/E07.083

(57) ABSTRACT

A conferencing system for an enterprise is disclosed. The conferencing system initiates a scheduled conference upon detecting that a scheduled conferee is present at a conferencing endpoint.

### CROSS REFERENCE TO RELATED APPLICATIONS

This application claims priority to Provisional U.S. patent application Ser. No. 61/177,942 entitled “Method and System for Launching a Scheduled Conference Based on the Presence of a Scheduled Participant” filed 13 May 2009, which is incorporated by reference herein in its entirety. This application is related to U.S. patent application Ser. No. 12/465,548 entitled “Method and System for Transferring a Conference Between a Mobile Communication Device and a Conferencing Terminal” filed 13 May 2009, which is incorporated by reference herein in its entirety. This application is also related to U.S. patent application Ser. No. 12/465,558 entitled “Method and System for Initiating A conference Based on the Proximity of a Portable Communication Device” and U.S. patent application Ser. No. 12/465,566 entitled “Method and System for Managing Conferencing Resources in a Premises” and U.S. patent application Ser. No. 12/465,574 entitled “Method and System for providing a User Interface to a Portable Communication Device for Controlling a Conferencing Session” each filed 13 May 2009 and each incorporated by reference in its entirety.

### FIELD OF THE INVENTION

The subject matter of the present disclosure relates to the field of audio and/or videoconferencing, and more specifically to launching a scheduled conference based on the presence of one or more scheduled participants.

### BACKGROUND

Audio, video, and multimedia conferencing is becoming more and more popular in day to day operation of corporations. An organization can have a plurality of conferencing terminals and/or virtual meeting rooms. The conferencing terminals may be of different types or models or from different vendors and may have different types of control panels. The diversity of different types of equipment, each using different types of control panels can make learning and using conferencing equipment challenging. These challenges present a barrier for many people who would otherwise take advantage of conferencing equipment. There is thus a need to make operating conferencing equipment, and in particular to make initiating a conference, user friendly.

### SUMMARY

The present disclosure provides a conferencing system and methods for initiating a scheduled conference based on the presence of one or more conferees. A scheduled conference is automatically initiated when one or more of the scheduled participants are determined to be present at their respective endpoints. The system provides a user interface that is unobtrusive. A user simply arrives at a room containing the conferencing equipment, (i.e., a conference room, an office, etc.) and the call commences automatically.

The conferencing system includes a conference controller communicatively connected to one or more conferencing endpoints and to a scheduling application. The conference controller is also communicatively connected to a participant detection system associated with at least one of the endpoints. The conference controller can determine from the participant detection system that a participant is present in the location of the endpoint. The conference controller can determine from the scheduling application if the participant is scheduled for a conference. When both conditions are met, the conference controller can initiate a connection between the endpoint and another endpoint. According to one embodiment, the conference controller is communicatively connected to endpoints associated with all of the participants and can initiate a conference when all participants are present at their respective endpoints. Alternatively, the conference controller may be connected to only a subset of the scheduled participants and can initiate a conference when this subset of participants is present at their respective endpoints when a conference is scheduled. The conference controller may also be communicatively connected to one or more databases containing participant identification parameters, endpoint parameters, and the like.

These and other aspects of the disclosure will be apparent in view of the attached FIGs. and detailed description.

### BRIEF DESCRIPTION OF THE DRAWINGS

Exemplary embodiments of the present invention will be more readily understood from reading the following description and by reference to the accompanying drawings, in which:

FIG. 1 illustrates an organization premises having a variety of electronic communication systems;

FIG. 2a is a simplified block diagram of an exemplary communication management server (CMS) that is implemented by a middleware server (MWS) while conducting conferencing sessions;

FIG. 2b is a simplified block diagram of an exemplary PAS transmitter (PAST);

FIG. 2c is a simplified block diagram of an exemplary PAS receiver (PASR);

FIG. 3 is a flowchart illustrating relevant processes for automatically initiating a conference;

FIG. 4 is a block diagram of an embodiment of a conferencing system according to an embodiment disclosed which includes a participant detection system located at an endpoint.

### DETAILED DESCRIPTION

Turning now to the figures in which like numerals represent like elements throughout the several views, exemplary embodiments, aspects and features of the present disclosure are described. The purpose of the drawings is to describe exemplary embodiments and not for production or limitation. Therefore, features shown in the figures are chosen for convenience and clarity of presentation only. Time diagrams shown in the figures are chosen for convenience and clarity of presentation and are not necessarily shown to scale.

An endpoint may provide speech only, speech and video, or speech, data and video communications. Exemplary endpoints include Polycom VSX 7000, HDX 9004, conference phone VTX 1000, etc., by Polycom, Inc. As used herein, the term multimedia endpoint refers to an endpoint on a network capable of providing real-time, two-way audio/video communications and may also provide data communication with other endpoints or with a multipoint control unit (MCU). An MCU is a conference controlling entity located at a node of a network or in a terminal, which receives and processes multiple media channels from access ports according to certain criteria and distributes them to the connected channels. Examples of MCUs include the RMX 2000, MGC-100 (Polycom Inc.). Other MCUs can be embedded within a multimedia endpoint. Some MCUs are composed from two logical units, a media controller (MC) and a media processor (MP). A more thorough definition of an endpoint (terminal) and an MCU can be found in the International Telecommunication Union (“ITU”) standards, such as but not limited to the H.320, H.324, H.323, and Session Initiation Protocol (SIP). Additional information regarding the ITU standards can be found at the ITU website www.itu.int information regarding SIP can be found in www.ietf.org.

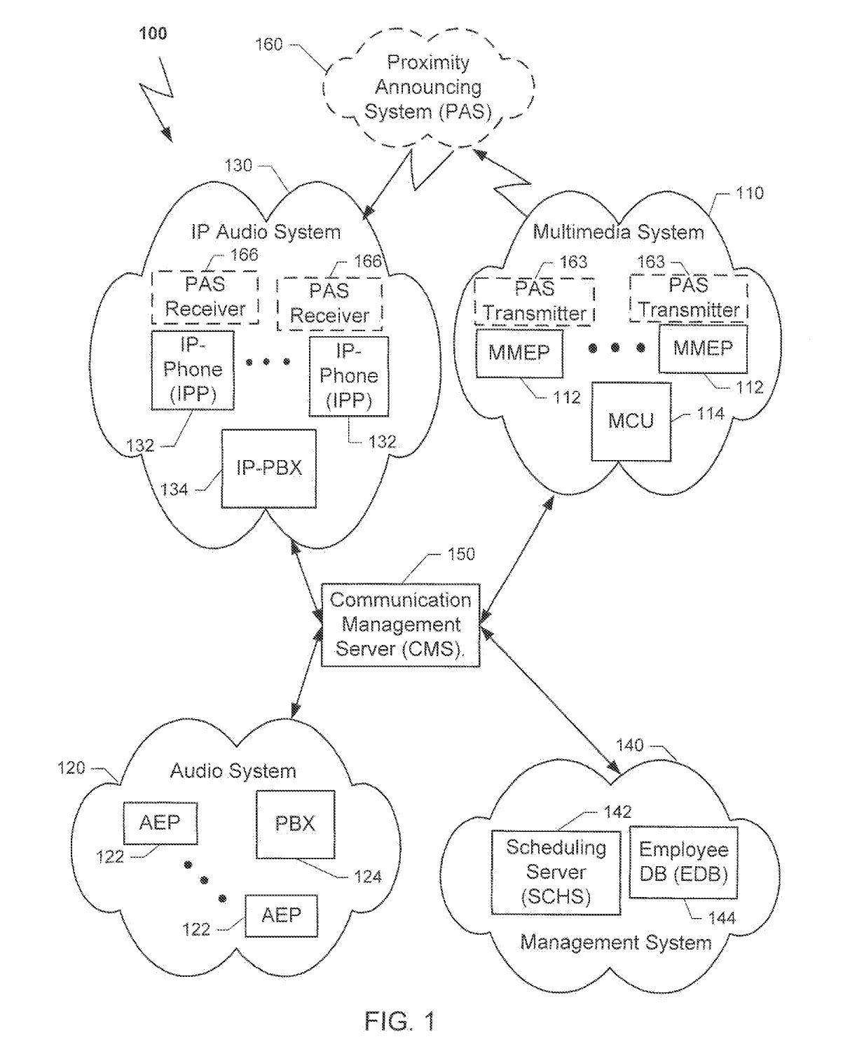

FIG. 1 is a block diagram illustrating an organization premises 100 having a multimedia system 110, an internet protocol (IP) audio system 130, a circuit switch audio system 120, a management system 140 a proximity announcing system (PAS) 160 and a communication management server (CMS) 150. In the example of premises 100, CMS 150 is implemented by a middleware server (MWS) that interfaces between those systems. Within each system cloud 110, 120, 130 and 140, elements of the system can communicate via a local network that can be a packet-switched network and/or circuit switched network. Those skilled in the art will appreciate that the number of systems, elements within a system as well as the CMS 150 shown in FIG. 1 are only exemplary and not limiting. It will be appreciated that the term organization premises is not limited to a physical location or structure. Exemplary audio system 120 can run over a circuit switch network such PSTN and among other elements may include a plurality of audio endpoints (AEP) 122. Exemplary AEP 122 can be POTS (plain old telephone service) telephones, conference room telephone such as VTX1000™ (Polycom Inc) etc. In addition, audio system 120 can include a private switching box PBX 124. PBX 124 can be a private switching box for routing calls between the different AEP 122, for audio conferences, and as interface between AEP 122 and the world outside of cloud 120.

IP audio system 130 can run over an IP network and may include a plurality of IP audio endpoints (IPAEP) 132. Exemplary IPAEP 132 can be IP Phones (IPP) such as but not limited to Sound Point IP 4000™ (Polycom); personal computers (PC), laptop computers, etc. capable of enabling audio sessions over an IP networks, etc. Some of the IPP can be wireless phones which can be used as personal communication device of an employee. Such a personal communication device can be associated with a proximity receiver 166, which is disclosed later on. In addition cloud 130 can comprise an IP-PBX 134. IP-PBX 134 can be used as a private switching box for routing calls between the different IPAEP 132, for audio conferences, and as an interface between the IPAEP 132 and the world outside cloud 130.

Multimedia system 110 can include one or more multipoint control units (MCU) 114 and a plurality of multimedia endpoints (MMEP) 112. Some of the MMEP 112 can run over an IP network, some over a circuit switch network, and some over both networks. Some of the MMEP 112 can also be used as an IPAEP 132 and vice versa. Some of the MMEP 112 can be used as an AEP 122 and vice versa. MCU 114 can be used for conducting multipoint audio and/or video and/or multimedia sessions between the different MMEP 112 and between some of the AEP 122 and/or some of the IPAEP 132. Point to point (PTP) multimedia session can be handled directly by the MMEP 112 or via MCU 114 if transcoding is needed. Transcoding is needed if the two endpoints are running over networks that use different communication protocols or the endpoints are using different compression standards, different bite rate, etc. In such cases MCU 114 serves as a gateway for converting protocols and/or compression standards or as interfaces between different networks, etc. Some of the MMEP 112 can be associated with a proximity announcing transmitter (a beacon) 163, which is discussed in more detail below. Embodiments of the disclosure are described as transferring a communication session from a personal communication device to a MMEP, but it should be realized that a communication session can be transferred from a personal communication device to any conferencing device, such as an audio conferencing endpoint, using the methods described herein.

Management system 140 is used for common operation of the organization and may include a scheduling server (SCHS) 142 such as MICROSOFT EXCHANGE SERVER™ (Microsoft) and an employee database (EDB) 144 that can include information on the employees of the organization including information such as names, employee's ID number, list of security permissions, email address, telephone numbers, IP address, buddy list, etc. Management system 140 may include other servers that are not shown, for example email servers, organizational web sites, etc.

Exemplary proximity announcing system 160 (PAS) can be a wireless system that is installed in the organization premises 100 to identify situations in which a personal communication device is in proximity with a multimedia endpoint. An exemplary PAS 160 can be based radio frequency (RF) technology using common protocol such as Bluetooth or a proprietary protocol. An alternate exemplary embodiment can be based on infrared technology (IR), or any other wireless technologies. PAS 160 can be unidirectional, having a plurality of PAS transmitters (PAST) 163 and a plurality of PAS receivers (PASR) 166. Alternatively, (not shown in the drawings) PAS 160 can be bidirectional, system having a plurality of proximity transmitters/receivers. Other exemplary PAS 160 can be based on commercial methods that are capable of identifying location and/or proximity. Exemplary PAS 160 can be based on GPS receivers, cellular phones, WiMAX, etc.

Further discussion of PAS and PASR configurations and capabilities may be found in U.S. patent application Ser. No. 12/465,566 entitled “Method and System for Managing Conferencing Resources in a Premises” incorporated by reference above.

Communication management server (CMS) 150 can be installed in the organizational premises 100 and can communicate with the one or more MCU 114, IP-PBX 134, PBX 124, SCHS 142, EDB 144. In other embodiments, CMS 150 additionally can communicate directly with some of the IPAEP 132, MMEP 112, and AEP 122. PASR 166 can communicate with CMS 150 directly or indirectly via an associated personal communication device 132 or an associated MMEP 112. The communication between CMS 150 and the different elements of premises 100 can be conducted over an IP network or any other data communication network that is used over the organizational premises 100. In the present description an IP network is used as an exemplary network for the communication between CMS 150 and the other elements of premises.

In one embodiment, CMS 150 can be implemented as an independent server. In other embodiments CMS 150 can be embedded within a network device of the organizational premises 100 such as, but not limited to, MCU 110, IP-PBX 130 or PBX 124. CMS 150 can be adapted to interface between the different communication systems (110, 120 and 130) and PAS 160. According to the requirements of the organization CMS 150 can be adapted to establish and manage multipoint multimedia conferencing sessions over the one or more communicational networks 110, 120 and 130 and/or transfer calls from one network to another.

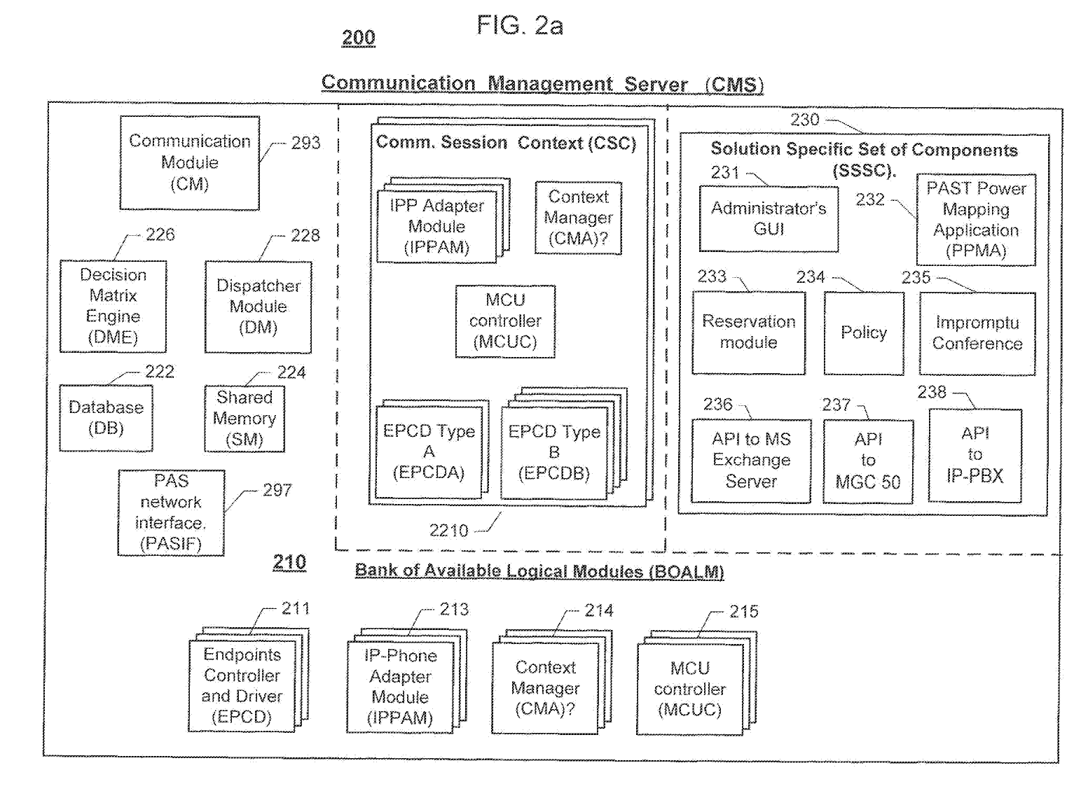

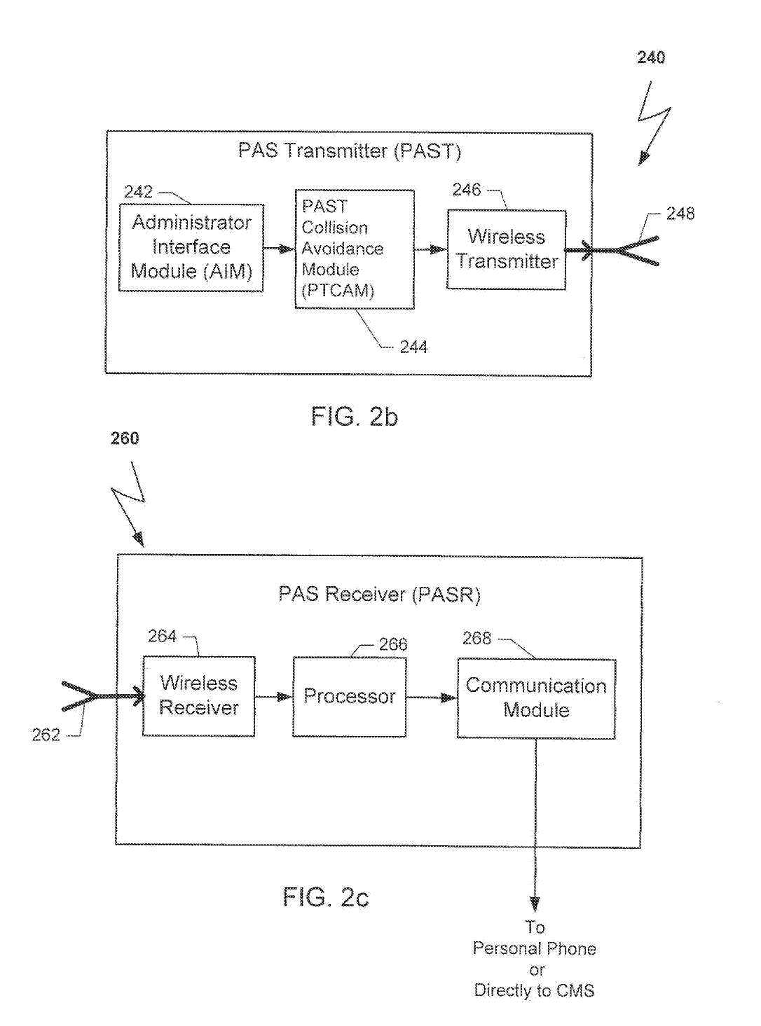

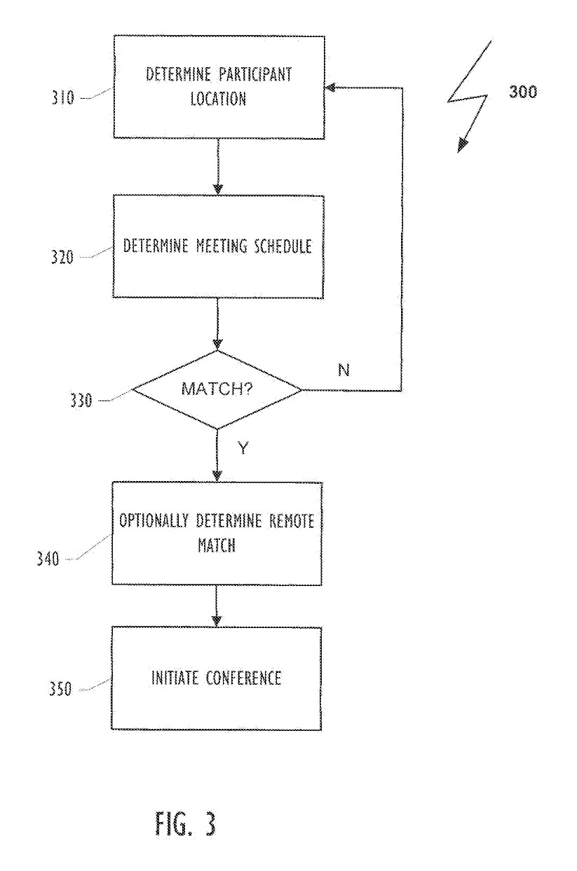

FIG. 2a is a block diagram of an exemplary CMS 200, which is implemented as a middleware server. FIG. 2a illustrates the modular nature of the CMS 200 with relevant functional modules needed for describing the operation of the PAS 160 (FIG. 1) with the different communicational and management systems for establishing and controlling one or more multimedia conferences. An exemplary CMS 200 can be divided into three sections: a basic set of components 210, a solution specific set of components (SSSC) 230, and ongoing-communication-session-contexts (CSC) 2210. An exemplary CSC 2210 can be allocated per each communication session that involves a PAS transaction and/or a multimedia session. CSC 2210 can be composed from a combination of logical modules that are included in a bank of available logical modules (BOALM) and are required for conducting the communication session. SSSC 230 can include a set of logical modules that are configured according to the needs of the organization in which CMS 200 is installed.

An exemplary basic set of components 210 can include a bank of available logical modules (BOALM), database (DB) 222, shared memory (SM) 224, decision matrix engine (DME) 226, dispatcher module (DM) 228, a communication module (CM) 293, and a PAS network interface module (PASIF) 297. CMS 200 can include other modules that are not shown in FIG. 2a, for example web services modules, etc. The BOALM can include several groups of logical modules 211 to 215, each group including a plurality of logical modules having the same functionality, but adapted to different types of equipment. As used herein, a logical module can be a physical entity or a logical entity that is composed from physical entities allocated to the logical module by the DM 228 when the logical module is needed in a context 2210 associated with a new conference. A logical module may be software, including a computer program, routine, or code, for example. Although three logical modules in a group are illustrated in BOALM, the present disclosure is not limited to a particular number and the presented configuration is intended to be illustrative of an exemplary configuration.

An exemplary BOALM includes a group of endpoint controller and drivers (EPCD) 211, a group of personal communication device (IP-Phone, for example) adapter modules (IPPAM) 213, a group of context manager applications (CMA) 214, and a group of MCU controllers (MCUC) 215. Other logical modules not illustrated can include a group of SIP components (SIPC) and/or a group of H.323 gatekeeper modules, etc.

An exemplary dispatcher module (DM) 228 can act as a managing module of the CMS 200 and controls the operation of the entire CMS 200. DM 228 may get requests for initiating or terminating a communication session and accordingly may allocate resources for a context that will be associated with the communication session or release resources of a context that is associated with a terminating session. The request can be received from a scheduling server 142 (FIG. 1) via its API 236, from one of the PASR 166 (FIG. 1) via PASIF 297, MCU 114 via the MCU API 237, etc. Based on the request, DM 228 can allocate resources from BOALM 210 according to the request, create a context with those resources, and associate the appropriate logical modules with relevant locations in the site DB. For example, the location of information on a certain MMEP in the site section of DB 222 is transferred to the relevant EPCD 211. DM 228 may use the services of DME 226 to determine the best configuration of the context. DM 228 is described in more detail below, following an overview of the other modular components of the CMS 200. After establishing and initiating the context, DM 228 may receive status information on the operation of the context. Based on this information, DM 228 may consider replacing some of the logical modules with others or terminating the context or part of the context and releasing their resources back to BOALM 210 or to SM 224, etc.

The group of EPCD 211 can include driver applications for a plurality of types of endpoints. Exemplary endpoints include VSX8000™ and VSX7000™ (Polycom Inc.). For a given conference, one or more EPCDs 211 are selected or created by DM 228 and assigned to a context 2210 associated with that conference according to the type of endpoints that are to be connected in the conference. An exemplary EPCD 211 can be adapted to communicate with its associated endpoint via CM 293 and inform the user to dial a certain ISDN number or an IP alias of an MCU for joining the conference. Alternatively, the endpoint can be adapted to be controlled by the EPCD 211 and automatically dial to the MCU 114 (FIG. 1) to join a conference. Exemplary methods for instructing an endpoint to set a connection with an MCU are disclosed in U.S. patent application Ser. No. 10/941,790, the entire contents of which are incorporate herein by reference. If the associated endpoint cannot be instructed or informed to call an MCU, then EPCD 211 can send the dialing number of the endpoint to a queue assigned to the relevant MCUC 215. The MCUC 215 can retrieve the information from its queue and instruct the MCU to dial the endpoint. Such an endpoint can be a POTS telephone, for example.

The database (DB) 222 can include several sections, including a system section (SSDB), a site DB, and active sessions DB (ASDB). The SSDB may include information on different type of communication devices such as different terminals IP-Phones, multimedia endpoints, controllers (MCU, PBX, IP-PBX), scheduling system, management system, etc. The SSDB can be prepared by the vendor of CMS 200 and can be sorted according to device type. The site DB may include information relevant to a current site (the organizational premises in which the CMS is installed) including user names, addresses (dial-in numbers, IP address, User's address book, etc.), type of endpoints, topology, etc. The site DB can be sorted according to user's name, controller ID number, etc. In addition it can include MMEP mapping table as well as indexing tables that delivers for each ID of MMEP 112 (FIG. 1) or a personal communication device 132 (FIG. 1) its communication parameters. Such parameters include type, module, dial in number or IP address, type of protocols, etc. This section can be adapted and configured during the installation of the system and can be updated from time to time by an administrator of the organization. The ASDB is a section in the DB in which each of the different modules of the CMS (multimedia, interfacing applications or business logic applications) store information used for their operation and store results of their operation to share with other modules. This section can be organized according to active sessions.

SM 224 can be implemented by a random access memory (RAM) that is used for interfacing between the different modules that are currently active. SM 224 may contain a bank of queues. Each queue can be associated with a current active module of the CMS. From such a queue each active module can retrieve information or a pointer to the next information or instruction that the module will need during its next process. The information itself can reside in the DB 222. This pointer and/or the information are placed in the queue by another active module that used or created this information. In some exemplary embodiments SM 224 can be embedded as a logical part in DB.

DME 226 may include a bank of algorithms that can be used by dispatcher 228, PASIF 297 or CMA 214 when a decision is needed. For example DME 226 may be requested to determine if a room has two MMEP which MMEP can be selected as nearby MMEP. The decision can be based on user experience, occupation of the MMEP, reservation of a certain MMEP, etc. In addition DME 228 can be used for determining if a user of PASR 166 that sent the nearby message is eligible to upgrade his session into multimedia session using the nearby MMEP, etc.

CM 293 is in charge on the communication between the CMS 200 and other equipment. For implementing data communication over a network using the Open System Interconnection (OSI) reference model, CM 293 is adapted to handle the first four layers: the physical layer 1, link layer 2, network layer 3, and the transport layer 4 (the TCP stack). In addition CM 293 may include a H.323 Gatekeeper Stack for working in H.323 protocol, and/or SIP stack for working in SIP protocol and/or HTTP server for working also as a web-server. In another embodiment CM 293 may include a communication module for communicating over ISDN, regular phones etc.

After installation of the system, the MCS 200 and PAS 160 (FIG. 1) can be configured to operate in the particular organization. The solution specific set of components (SSSC) 230 provides functional modules that are specifically needed to solve the requests/needs of the organization in which the CMS 200 is installed and for adapting the operation of CMS 200 to the needs of the systems that are installed in the organization premises. Exemplary SSSC 230 may include one or more application program interfaces (API) 236, 237 & 238, business logic modules such as reservation module 233, policy module 234 and impromptu conference module 235 and administrator tools. Exemplary administrator's tools can include a graphical human interface (GUI) 231 to be used by an administrator of the organization and PAST power mapping application (PPMA) 232.

An API may be needed for each of the systems that are installed in the organizational premises 100 (FIG. 1). For example if the multimedia system 110 (FIG. 1) includes two or more types of MCUs 114, an API 237 for each type of MCU is needed. An API 238 is needed for each type of PBX 124 and/or each type of IP-PBX 134 that are installed in premises 100. Furthermore an API 236 may be needed for interfacing with a scheduling server 142 and EDB 144.

Exemplary business logic modules are adapted to the requirement of the organization and its one or more policies if such exist. For example, reservation module 233 may include a set of rules defining employees' rights for scheduling a multimedia session. Policy module 234 can include security limitation for preventing access to multimedia conferences, maximum length of a multimedia session, type of layouts, policy for selecting one or more speakers in a conference, maximum number of conferees in a conference, etc. Impromptu conference module can include information regarding who is entitled to start an impromptu session over which MMEP, in which hours, etc.

Administrator's GUI 231 can also be adapted to the requirements of the organization and may include the logo of the organization, the same icons used in the organization site, same maintenance page-format that is used by the administrator of the network, etc. The GUI may include forms for associating the plurality PAST 163 (FIG. 1) with MMEP 122 (FIG. 1) or with rooms as well as forms for associating PASR 166 (FIG. 1) with personal communication devices 112 (FIG. 1).

PAST power mapping application (PPMA) 232 can be capable of generating a mapping table in which each entry is associated with a room or a MMEP. Each entry can be defined by a combination of received power that is observed with several PASR 166 (FIG. 1) at a certain room, for example. After initiating the mapping application 232 an administrator is requested to get one or more personal communication devices 132 with its associated PASR 166 and to visit the rooms that have one or more MMEPs 112. At each room the administrator can walk around while the PASRs 166 that are involved in the mapping process send their nearby messages to PASIF 297 which process the message and transfer the ID number of the PAST with their received power to PPMA 232.

Per each room PPMA 232 can calculate an average power of a signal received from each PAST 163. The average power can be the average of the plurality of PASR 166 and messages that were received from plurality of locations in the room. Then per each room a list is prepared; each entry in the list includes the ID number of a PAST (or associated MMEP or associated room) and the average power of its signal. The list can be sorted according to the average power and the combination of the sorted ID number can define the room. After measuring all the rooms, PPMA 232 can create a mapping table in which each entry can be associated with a room, for example, and each entry include the combination that was calculated during the measuring step. Each entry may include one or more MMEP 112 that can be used as a nearby MMEP when a user enters this room. During day to day operation as PPMA idles it may be initiated from time to time by the administrator. Other embodiments may use other mapping methods for PAS 160 to the organization premises 100.

Further discussion regarding a CMS can be found in U.S. patent application Ser. No. 12/465,566 entitled “Method and System for Managing Conferencing Resources in a Premises” incorporated by reference above.

FIG. 2b is a block diagram of an exemplary PAST 240. FIG. 2b illustrates relevant elements of PAST 240. An exemplary PAST can include an administrator interface module (AIM) 242, a PAST collision avoidance module (PTCAM) 244, a wireless transmitter 246 and an antenna 248. An exemplary PAST 240 can be associated with a MMEP, such as MMEP 112 (FIG. 1). Alternatively PAST 240 can be embedded within a MMEP 112. In other exemplary configurations PAST 240 can be associated with a room. In such embodiment PASIF 297 (FIG. 2a) may use an index table in which each entry is associated with a room ID and contains information about one or more MMEP 112 which are associated with the room. The index table can be prepared by an administrator of network 100 (FIG. 1), using GUI 231 (FIG. 2a), during installation of PAS 160 (FIG. 1). Yet in an alternate configuration of PAS 160, an exemplary PAST 240 can be associated with a personal communication device such as IPP 132 (FIG. 1); alternatively it can be embedded within a personal communication device. In other exemplary configurations PAST 240 can be associated with a user, using an employee RFID card, for example. In such embodiment PASIF 297 (FIG. 2a) may use an index table in which each entry is associated with a user ID and contains information about his personal communication device.

Administrator interface module 242 is used by the administrator of system 100 (FIG. 1) for associating a PAST 240 with an MMEP or a personal communication device or a user according to the implementation of PAS 160. An exemplary AIM 242 can be a set of switches by which the administrator defines the ID number of the PAST 240. In alternate embodiment of PAST 240 AIM 242 can be a preloaded flash memory loaded with an ID number of PAST 240. Yet in another embodiment of PAST 240 the ID number can be loaded via the administrator's computer. After loading the ID number to PAST 240 the administrator using GUI 231 adds an entry to the index table in which the association of the PAST ID and according to the implementation of PAS 160 a user or a personal communication device or MMEP is stored. The index table can be stored in DB 222 (FIG. 2a). The PAST ID number stored in AIM 242 is used by PTCAM 244. In an alternate exemplary embodiment AIM 242 can be a network connection for remotely configuration

PAST collision avoidance module, PTCAM 244, is used for preventing collision of information received from different PAST by the same PASR. Several collision avoidance methods can be implemented by different embodiments of PAS 160 (FIG. 1). An exemplary PAS 160 can use frequency sharing method in which each PAST 240 transmit in a unique frequency. The frequency reflects the ID number associated with the PAST and stored by AIM 242. In such embodiment PTCAM can be a synthesizer that generates a RF signal in a frequency that matches the stored ID value of PAST 240. A plurality of collision avoidance methods can be implemented by different embodiments of the present invention. Some embodiments may use time division methods (TDM), others may use snooping methods. In other embodiments the collision avoidance methods may comply with common wireless protocols for short range communication or proximity. Exemplary short range protocols can be Bluetooth, WI-Fi, etc.

Wireless transmitter 246 can be an RF transmitter using an RF antenna 248 using a single carrier or a plurality of carrier wherein each carrier is associated with the PAST ID number. Alternatively, PAS 160 wireless transmitter 246 can be infrared transmitter using a lens as antenna 248. The modulation can be amplitude modulation (AM), frequency modulation (FM), phase modulation (PM), or any other type of modulation.

Other exemplary embodiments can use common wireless protocols for short range communication or proximity. Exemplary short range protocols can be Bluetooth, WiFI, etc.

FIG. 2c is a block diagram of an exemplary PASR 260. An exemplary PASR 260 can include an antenna 262, a wireless receiver 264, a processor 266, and a PASR communication module (PRCM) 268. An exemplary PASR 260 can be associated with a personal communication device, such as IPP 132 (FIG. 1); alternatively it can be embedded within a personal communication device. In other exemplary configurations PASR 260 can be associated with a MMEP, such as MMEP 112 (FIG. 1). Alternatively PASR 260 can be embedded within a MMEP 112. In other exemplary configurations PASR 260 can be associated with a room. In such embodiment PASIF 297 (FIG. 2a) may use an index table in which each entry is associated with a room ID and contains information about one or more MMEP 112 associated with the room. The index table can be prepared by an administrator of network 100 (FIG. 1), using GUI 231 (FIG. 2a), during installation of PAS 160 (FIG. 1).

In one exemplary embodiment wireless antenna 262 and receiver 264 are based on IR technology. Therefore the antenna can be an array of lenses while the receiver can be an IR detector. If PAS 160 (FIG. 1) is based on RF technology receiver 264 match the collision avoidance and method and transmission technologies that is used. For example if the collision avoidance method is frequency deviation, then receiver 264 can scan the frequency band from one carrier to the other searching for a received signal. When a signal is detected the scanning holds for a certain period in which the signal is detected, the power of the received signal is measured and the detected signal with its power indication as well as the frequency of the received signal are transferred to processor 266. In some exemplary embodiments the carrier signal is not modulated with the ID number since the frequency of the received signal can reflect the ID number of the PAST that sent the signal. After transferring the information to the processor the scan can continue and the receiver can move toward another carrier if exist. At the end of the receiving frequency band the scanning start from the beginning One scanning cycle can be referred as measuring period or monitoring period.

Other exemplary embodiments can use common wireless protocols for short range communication or proximity. Exemplary short range protocols can be Bluetooth, WiFI, etc.

An exemplary processor 266 can be adapted to receive the detected signal and its power from the receiver. The detected signal can be processed and converted into the ID number. Then the ID number and its power are transferred to the communication module 268 to be sent toward PASIF 297. Further processing of the received nearby massages is implemented by PASIF 297 (FIG. 2a) as disclosed above. In other embodiments of PASR 260 the processor 266 can be adapted determine which received ID number is the dominant and can be defined as the nearby MMEP. Processor 266 can average several consecutive received signals of the same PAST in order to determine an average power value of the PAST. The average received power of all received PASTs are compared and the one with highest power can be defined as the nearby MMEP. In such embodiment only the final decision is transferred to the communication module 268.

Communication module 268 receives the data from processor 266 and manipulates it according to a format of a nearby message that complies with the communication protocol used by CM 293 (FIG. 2a) and PASIF 297. In one embodiment the nearby message is transferred to the associated personal communication device and from there is sent toward CM 293. In another exemplary embodiment communication module 268 is capable of establishing a direct connection with CM 293 on which the nearby message is transferred.

FIG. 3 illustrates relevant processes 300 for automatically initiating a conference based on the proximity of a scheduled participant. Beginning at block 310 a participant's location can be determined utilizing any of the methods disclosed herein. Next at block 320 a meeting schedule may be retrieved from a scheduling server. The participants scheduled for a meeting at a particular location may be matched at block 330. If no match is found another participant can be selected to repeat process 300 from the beginning If a match for a participant is found at a first location flow can continue to block 340 and optionally determine if a scheduled remote participant has arrived at the scheduled remote meeting location. After all required determinations have resulted in a match the conference can be automatically initiated at block 350.

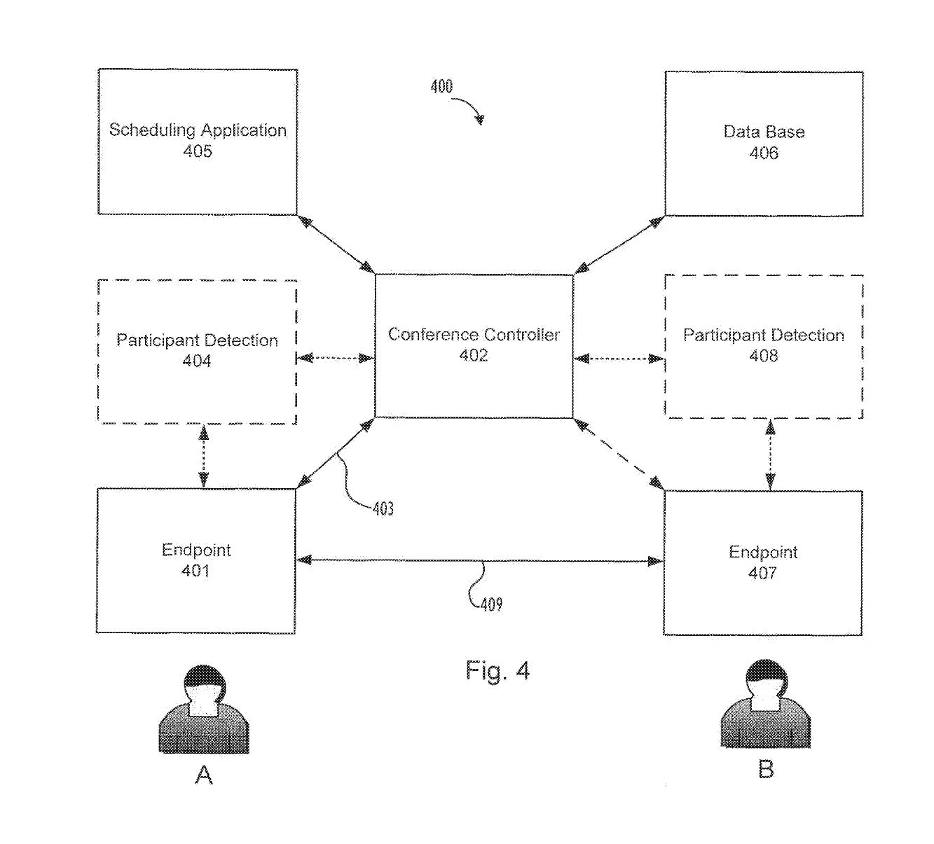

Another embodiment of a conferencing system 400 is illustrated in FIG. 4. The illustrated conferencing system includes conferencing endpoint 401 communicatively connected to conference controller 402 via connection 403. Endpoint 401 can be an audio, video, or multimedia conferencing endpoint. Conference controller 402 can be any type of computer device, such as a dedicated computer or a middleware server that is connected to other communicational controllers. Conference controller 402 can be connected to or imbedded in a private IP-phone switching box (IP-PBX), one or more MCUs, management servers (such as MS server, for example), and one or more multimedia endpoints; etc. The conference controller 402 can be capable of routing calls to and from multimedia endpoints and IP phones via controlling the organizational MCUs, IP-PBX and the plurality of multimedia endpoints. In addition it can add or remove one or more participants to or from a currently conducted session. Conferencing endpoint 401 can be connected to conference controller 402 via a network connection, for example.

Conferencing system 400 also includes a participant detection system 404 associated with endpoint 1 for detecting persons located at endpoint 401. Participant detection system 404 can be an integral part or function of endpoint 1 or can be a separate system associated with the location of endpoint 1. Participant detection system 404 will be described in more detail below. Participant detection system 404 is communicatively connected to conference controller 402, either by its own network connection or via endpoint 401 or via an additional network device such as an additional server (not illustrated).

Conference controller 402 is communicatively connected to scheduling application 405. Scheduling application 405 may be integral with conference controller 402 or may be comprised in a separate computer device. An example scheduling application 405 is scheduling server such as MICROSOFT EXCHANGE SERVER™ (Microsoft). Scheduling application 405 comprises information about conferences scheduled by participants within the premises and/or enterprise. Scheduling application 405 may include information such as the time of scheduled conference, the participants scheduled to participate in the conference, the duration of the conference, and contact/connection parameters for conferencing devices that will participate in the conference. Conference controller 402 is also communicatively connected to database 406 that can include information on the employees of the organization including information such as names, employee's ID number, list of security permissions, email address, telephone numbers, IP address, buddy list, etc. Database 406 also includes participant identification parameters used in combination with participant detection system 404, as explained in more detail below. Database 406 may be integral with conference controller 402, with scheduling application 405, or may be comprised in one or more separate computing devices.

In conferencing system 400, conference controller 402 uses information from participant detection system 404, scheduling application 405 and database 406 to automatically initiate a conference at endpoint 401 upon the arrival of a scheduled participant at endpoint 401. For example, conference controller may determine from scheduling apparatus 405 that participant A is scheduled for a conference with participant B at a given time. When conference controller determines that participant A is located at endpoint 401 at or near the time scheduled for the conference, conference controller initiates a connection between endpoint 401 and endpoint 407 associated with participant B. Conference controller can obtain connection parameters for endpoint 407 from scheduling application 405 and/or from database 406 and instruct endpoint 401 to initiate a connection with endpoint 407. If endpoint 407 is within the same premises or enterprise, then endpoint 407 may also be associated with a participant detection system 408. In such case, conference controller may wait until it determines that both participants A and B are located at their respective endpoints before initiating the conference.

According to one embodiment of conferencing system 400, conference controller uses face recognition to determine if participant A is present at endpoint 401. If endpoint 401 is a videoconferencing endpoint, the camera of endpoint 401 detects persons within the view of the camera. Face recognition software at conference controller 402 can identify people within view of the camera, for example, by comparing their facial features against facial samples contained in database 406. This task can be minimized by only searching for scheduled participants. When participant A is recognized, the conference is initiated. Alternatively, the conference controller may wait until participant B is also recognized at an endpoint before initiating a conference.

According to one embodiment, the conference controller 400 can initiate a conference from any endpoint where the conference controller determines participant A to be present. Participant A may have a choice of conducting a conference using one of several conferencing devices that are connected to conference controller 402. For example, participant A may conduct a scheduled conference from a conferencing device in his office, a colleague's office, a conference room, etc. Using conferencing system 400, participant A is not required to be familiar with how to operate each of these conferencing devices. Instead, participant A simply arrives at one of these devices at the appropriate time and the conference controller determines that participant A is scheduled for a conference and initiates the conference automatically.

Any system capable for detecting the presence of a participant at a conferencing endpoint can be used in the conferencing system 400. In the scenario described above, endpoint 401 is a videoconferencing endpoint and the camera of endpoint 401, in combination with data and software at conference controller 402 and/or database 406 constitutes a participant detection system. Alternatively, voice recognition can be used to determine that a participant is present at either a videoconferencing or audio conferencing endpoint. A camera and/or microphone independent of the camera and/or microphone incorporated into conferencing endpoint can be implemented for participant identification; it is not necessary that the camera/microphone be a part of the conferencing endpoint.

Other techniques of determining the presence of a participant at an endpoint can be used. For example, a participant may be determined to be in a conference room or an office containing a conferencing endpoint using an RFID tag in an employ badge or an ID card slid through a card reader. Other techniques include finger print identification and retinal scan. A sensor in a chair can be used to determine if a conferee is sitting in the chair.

Upon determining that a person is present at a conferencing device, conferencing system 400 may query the person to determine if the person is a scheduled participant, and if so, is the person wished to proceed with the conference. This may be done by a voice interactive response system or by a graphical user interface of the conferencing device, for example.

Though only a point to point communication is illustrated in FIG. 5, system 400 can also be used to conduct multipoint conferencing between three or more parties by including a bridge or MCU in the system.

In the present disclosure, the words “unit,” “element,” “module” and “logical module” can be used interchangeably. Anything designated as a unit or module can be a stand-alone unit or a specialized or integrated module. A unit or a module can be modular or have modular aspects allowing it to be easily removed and replaced with another similar unit or module. Each unit or module may be any one of, or any combination of, software, hardware, and/or firmware. Software of a logical module can be embodied on a computer readable medium such as a read/write hard disc, CDROM, Flash memory, ROM, etc. In order to execute a certain task a software program can be loaded to an appropriate processor as needed.

In the description and claims of the present disclosure, “comprise,” “include,” “have,” and conjugates thereof are used to indicate that the object or objects of the verb are not necessarily a complete listing of members, components, elements, or parts of the subject or subjects of the verb.

It will be appreciated that the above described apparatus, systems and methods can be varied in many ways, including, changing the order of steps, and the exact implementation used. The described embodiments include different features, not all of which are required in all embodiments of the present disclosure. Moreover, some embodiments of the present disclosure use only some of the features or possible combinations of the features. Different combinations of features noted in the described embodiments will occur to a person skilled in the art. Furthermore, some embodiments of the present disclosure can be implemented by combination of features and elements that have been described in association to different exemplary embodiments along the disclosure. The scope of the invention is limited only by the following claims.

We claim:

1. A method of initiating a conference between a plurality of conferencing devices, the method comprising:
receiving an indication of a scheduled conference from a scheduling application wherein the indication includes a list of invitees;
determining a time duration for the scheduled conference;
determining a presence at a first location of at least one invitee in a proximity of a first conferencing system within the time duration; and
automatically initiating the scheduled conference.

2. The method of claim 1 further comprising:
determining a presence at a second location of at least one invitee in a proximity of a second conferencing system within the time duration prior to automatically initiating the scheduled conference.

3. The method of claim 1 wherein the conference is an audio conference.

4. The method of claim 1 wherein the conference is a video conference.

5. The method of claim 1 wherein the act of determining a presence comprises:
receiving participant identification parameters;
monitoring the first location for input data; and
processing the input data to determine a match with at least a portion of the received participant identification parameters.

6. The method of claim 5 wherein the monitored input data comprises audio data and processing the input data to determine a match comprises using voice recognition software.

7. The method of claim 5 wherein the monitored input data comprises video data and processing the input data to determine a match comprises using face recognition software.

8. The method of claim 5 wherein receiving participant identification parameters comprises receiving participant identification parameters for the list of invitees.

9. The method of claim 1 wherein determining a presence at a first location comprises using face recognition software.

10. The method of claim 1 wherein determining a presence at a first location comprises using voice recognition software.

11. The method of claim 1 wherein determining a presence at a first location comprises using an radio frequency identification (RFID) tag for identification.

12. The method of claim 1 wherein determining a presence at a first location comprises using a card reader to read an identification card.

13. The method of claim 1 further comprising:
determining a presence at a second location of at least one invitee in a proximity of a second conferencing system within the time duration and automatically joining the conference.

14. A conferencing system comprising:
a scheduling application; and
a first conferencing device at a first location communicatively coupled to the scheduling application and comprising a programmable processor wherein the programmable processor is programmed to:
receive an indication of a scheduled conference from the scheduling application wherein the indication includes a list of invitees;
determine a time duration for the scheduled conference;
determine a presence at the first location of at least one invitee in a proximity of a first conferencing system component within the time duration; and
automatically initiate the scheduled conference.

15. The conferencing system of claim 14 wherein the programmed act of determining a presence at a first location comprises using face recognition software.

16. The conferencing system of claim 14 wherein the programmed act of determining a presence at a first location comprises using voice recognition software.

17. The conferencing system of claim 14 wherein the programmed act of determining a presence at a first location comprises using an radio frequency identification (RFID) tag for identification.

18. The conferencing system of claim 14 wherein the programmed act of determining a presence at a first location comprises using a card reader to read an identification card.

19. The conferencing system of claim 14 wherein the programmed act of determining a presence comprises:
receiving participant identification parameters;
monitoring the first location for input data; and
processing the input data to determine a match with at least a portion of the received participant identification parameters.

20. The conferencing system of claim 14 further comprising:
a second conferencing device at a second location communicatively coupled to the scheduling application and comprising a programmable processor wherein the programmable processor is programmed to:
determine a presence at the second location of at least one invitee in a proximity of a second conferencing system within the time duration prior to automatically initiating the scheduled conference.

21. The conferencing system of claim 14 further comprising:
a second conferencing device at a second location communicatively coupled to the scheduling application and the first conferencing device, the second conferencing device comprising a programmable processor wherein the first conferencing device and the second conferencing device collectively determine that at least one invitee is in proximity prior to automatically initiating the scheduled conference.
